(19) United States
(12) Patent Application Publication
(10) Pub. No.: US 2021/0386523 A1
(43) Pub. Date: Dec. 16, 2021

(54) ORTHODONTIC INDIRECT BONDING APPARATUS

(71) Applicant: 3M INNOVATIVE PROPERTIES COMPANY, St. Paul, MN (US)

(72) Inventors: Richard E. Raby, Lino Lakes, MN (US); James L. Graham, II, Woodbury, MN (US); Kathleen M. Stenersen, Saint Paul, MN (US)

(21) Appl. No.: 17/417,847

(22) PCT Filed: Dec. 30, 2019
(86) PCT No.: PCT/IB2019/061446

§ 371 Date: Jun. 24, 2021

Related U.S. Application Data
(60) Provisional application No. 62/787,126, filed on Dec. 31, 2018.

(51) Int. Cl. A61C 7/14; A61C 7/00

(52) U.S. Cl. CPC A61C 7/146; A61C 7/002

(57) ABSTRACT

An orthodontic indirect bonding apparatus including integral custom bracket bonding pads and methods of making. The indirect bonding apparatus includes a receptacle having a frame at least partially surrounding the custom bracket bonding pad perimeter, the receptacle joined to the bracket bonding pad with a sprue and configured to receive a tooth. The custom bracket bonding pad is configured to complement contours of a portion of the tooth surface. The bracket bonding pad is formed integrally with the receptacle.

### TECHNICAL FIELD

This disclosure broadly relates to orthodontic indirect bonding apparatus that is useful for affixing orthodontic appliances to a patient's teeth. More particularly, the present disclosure is directed towards orthodontic indirect bonding apparatus including integral custom bracket bonding pads.

### BACKGROUND SUMMARY

Orthodontic treatment involves movement of malpositioned teeth to desired locations in the oral cavity. Orthodontic treatment can improve the patient's facial appearance, especially in instances where the teeth are noticeably crooked or where the jaws are out of alignment with each other. Orthodontic treatment can also enhance the function of the teeth by providing better occlusion during mastication.

One common type of orthodontic treatment involves the use of tiny, slotted appliances known as brackets. The brackets are fixed to the patient's teeth and an archwire is placed in the slot of each bracket. The archwire forms a track to guide movement of teeth to desired locations. The ends of orthodontic archwires are often connected to small appliances known as buccal tubes that are, in turn, secured to the patient's molar teeth. In many instances, a set of brackets, buccal tubes and an archwire is provided for each of the patient's upper and lower dental arches. The brackets, buccal tubes, and archwires are commonly referred to collectively as “braces”.

In general, orthodontic appliances that are adapted to be adhesively bonded to the patient's teeth are placed and connected to the teeth by either one of two procedures: a direct bonding procedure or an indirect bonding procedure. In the direct bonding procedure, the appliance is commonly grasped with a pair of tweezers or other hand instrument and placed by the practitioner on the surface of the tooth in its desired location, using a quantity of adhesive to fix the appliance to the tooth. In the indirect bonding procedure, a transfer tray is constructed with wall sections having a shape that matches the configuration of at least part of the patient's dental arch, and appliances such as orthodontic brackets are releasably connected to the tray at certain, predetermined locations. After an adhesive is applied to the base of each appliance, the tray is placed over the patient's teeth and remains in place until the adhesive has hardened. The tray is then detached from the teeth as well as from the appliances such that the appliances previously connected to the tray are bonded to the respective teeth at their intended, predetermined locations.

Indirect bonding techniques offer several advantages over direct bonding techniques. For example, it is possible with indirect bonding techniques to bond a plurality of appliances to a patient's dental arch simultaneously, thereby avoiding the need to bond each appliance in individual fashion. In addition, the transfer tray helps to locate the appliances in their proper, intended positions such that adjustment of each appliance on the surface of the tooth before bonding is avoided. The increased placement accuracy of the appliances that is often afforded by indirect bonding procedures helps ensure that the patient's teeth are moved to their proper, intended positions at the conclusion of treatment.

The present disclosure relates generally to orthodontic indirect bonding apparatus including integral custom bracket bonding pads. In one embodiment, provided is an apparatus for indirect bonding of orthodontic appliances, the apparatus comprising a first receptacle, the first receptacle configured to receive a first tooth, the first tooth having an outer surface and gingival margins; and a first bracket bonding pad, the first bracket bonding pad including a first bonding surface and a first perimeter, the first bonding surface configured to complement contours of a portion of the first outer surface of the first tooth, wherein the first receptacle comprises a first frame, the first frame at least partially surrounding the first bracket bonding pad first perimeter, wherein the first receptacle is joined to the first bracket bonding pad with a sprue, the sprue including a first end and a second end, wherein the first end of the sprue is attached to the first frame and the second end of the sprue is attached to the first bracket bonding pad first perimeter, and wherein the first bracket bonding pad is formed integrally with the first receptacle.

Features and advantages of the present disclosure will be further understood upon consideration of the detailed description as well as the appended claims.

### BRIEF DESCRIPTION OF THE DRAWINGS

FIG. 1 is an oblique view of a first embodiment of an indirect bonding apparatus of the present disclosure including a plurality of interconnected receptacles having an open framework, custom bracket bonding pads, and frangible sprues.

FIG. 2 is an oblique view of a portion of the apparatus of FIG. 1.

FIG. 3 is an oblique view of a portion of the apparatus of FIG. 1 with brackets bonded to the custom bracket bonding pads.

FIG. 4 is a portion of a second embodiment of an indirect bonding tray of the present disclosure including a receptacle having an open framework, a custom bracket bonding pad, and tapered frangible sprues.

FIG. 5 is a section of the portion of the indirect bonding tray of FIG. 4 showing the bracket bonding pad second major surface.

FIG. 6 shows the portion of the indirect bonding tray of FIG. 4 with a bracket bonded to the custom bracket bonding pad, the indirect bonding pad seated on a dental arch.

FIG. 7 is a portion of a third embodiment of an indirect bonding tray of the present disclosure including a receptacle having an open framework, a custom bracket bonding pad, and a continuous frangible sprue on a dental arch.

FIG. 8 shows a section of the indirect bonding tray of FIG. 7 with a bracket bonded to the custom bracket bonding pad.

FIG. 9 is an oblique view of the indirect bonding tray of FIG. 1 including brackets and seated on a dental arch.

FIG. 10 is an oblique view of the indirect bonding tray of FIG. 1 including a flexible, opaque overmolding incorporating bracket apertures.

FIG. 11 is an oblique view of the indirect bonding tray of FIG. 1 including a flexible, transparent overmolding incorporating bracket apertures and having brackets bonded to custom bonding pads.

FIG. 12 is an oblique view of the indirect bonding tray of FIG. 1 including a flexible, transparent overmolding encapsulating brackets bonded to the custom bracket bonding pads.

FIG. 13 is an oblique view of a portion of a dental arch following removal of parts of the indirect bonding tray not bonded to the dental arch and showing the gap between the bracket base and tooth filled by a custom bracket bonding pad.

FIG. 14 is a distal view of a buccal tube (i.e., molar bracket) following removal of parts of the indirect bonding tray not bonded to the dental arch showing a custom bracket bonding pad with a fillet around its perimeter.

FIG. 15 is an oblique view of a fourth embodiment of an indirect bonding tray of the present disclosure including a plurality of interconnected, open-framework receptacles, custom bracket bonding pads, and frangible sprues, where the custom bracket bonding pads are exposed on their gingival side and the tray is seated on a dental arch.

FIG. 16 is an oblique view of the indirect bonding tray of FIG. 15 including a flexible, transparent overmolding incorporating bracket apertures and having brackets bonded to custom bonding pads.

FIG. 17 is an oblique view of a fifth embodiment of an indirect bonding tray of the present disclosure including a plurality of open framework of interconnected receptacles, custom bracket bonding pads, and frangible sprues, where brackets are bonded to the custom bonding pads and the lingual tooth surfaces are exposed when the tray is seated on the dental arch.

FIG. 18 is an oblique view of the indirect bonding tray of FIG. 17 including a flexible, transparent overmolding encapsulating the indirect bonding tray, brackets, and the lingual tooth surface.

FIG. 19 is an oblique view of a portion of a sixth embodiment of an indirect bonding tray of the present disclosure showing a single receptacle having a closed framework, a custom bracket bonding pad, and beveled frangible sprues.

FIG. 20 is an oblique view of the single receptacle of FIG. 19 further including score lines.

FIG. 21 is an oblique view of a portion of a seventh embodiment of an indirect bonding tray of the present disclosure showing a single, open-framework receptacle, a custom bracket base having a custom bonding pad, and frangible sprues.

FIG. 22 is an oblique view of the portion of the embodiment of the indirect bonding tray of FIG. 21 showing a bracket body joined to the custom bracket base and seated on a dental arch.

FIG. 23 is an oblique view of a portion of an eighth embodiment of an indirect bonding tray of the present disclosure showing a single receptacle having a closed framework with score lines, a custom lingual bracket base having a custom bonding pad, and frangible sprues.

FIG. 24 is an oblique view of the portion of the indirect bonding tray of FIG. 23 showing a bracket body joined to the custom lingual bracket base and seated on a dental arch.

FIG. 25 is an oblique view of the portion of the indirect bonding tray of FIG. 24 following removal of parts of the indirect bonding tray not bonded to the dental arch.

FIG. 26 is an occlusal view of a custom bonding pad allowing for an extreme in/out dimension.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Provided in the present disclosure is an indirect bonding apparatus that includes one or more custom bracket bonding pads, the bracket bonding pads configured to fill the gaps between the patient's teeth and brackets having standardized bases. The custom bracket bonding pads may be formed integrally with a portion of the indirect bonding apparatus of the same material, with the custom bracket bonding pads connected to the indirect bonding apparatus by a plurality of frangible sprues. The frangible sprues may be connected to the perimeters of the custom bracket bonding pads. Brackets may be bonded to the custom bracket bonding pads using a suitable low-viscosity adhesive prior to indirect bonding. The indirect bonding apparatus is optionally designed with an open framework to allow for mechanical flexibility and overmolding with an elastomeric material, such as RTV silicone rubber. Overmolding can desirably allow for securement of brackets in the same matrix as the indirect bonding apparatus while allowing the brackets to tear-out upon removal of the indirect bonding apparatus from the patient's teeth, at which time the frangible sprues are also broken to allow separation of the custom bracket bonding pads from the rigid framework of the indirect bonding apparatus.

Most orthodontic brackets are mass produced, and the designs used in their bonding bases are derived from a “one-shape-fits-all” principle for each distinct tooth type in a dental arch. Individual variations in dental anatomy from the statistical norm, however, result in a compromised bracket fit for most teeth and most patients. As a result of this compromised fit, direct bonding techniques have historically involved the use of highly filled adhesives, such as, for example, TRANSBOND LR or TRANSBOND XT Light Cure Adhesive, available from 3M Company, St. Paul, Minn., USA. These adhesives are composite resins, comprising relatively low-viscosity, photo-curable methacrylate resin and a high concentration of microscopic ceramic particles. Together, the methacrylate resin and the ceramic particles form a high-viscosity paste, which solidifies into a solid concretion upon exposure to blue or UV light. When used in direct-bonding procedures, these adhesives join the base of each bracket directly to its respective tooth. Such adhesives are also commonly used in indirect bonding procedures.

In indirect bonding procedures, rather than directly joining each bracket to a tooth, a model of the patient's teeth is used as an intermediate. Indirect bonding processes may be desirable for several reasons including, for example, that they may allow the position of the bracket on the tooth to be better visualized and more carefully planned and that the model can act as a mold for the tooth-side of the adhesive when pre-forming a custom bonding pad on each bracket base and as a mold for an indirect bonding tray that captures the dental anatomy and brackets in relation to one another simultaneously.

In both direct and indirect bonding procedures, typically an excess of adhesive must be applied to the bracket base in order to ensure that the gap between the base and tooth is completely filled once the bracket has been pressed into place, though it is generally understood by those of skill in the relevant arts that a close fit between the bonding base and the tooth is preferred, as excessively thick bonding pads have been shown to be weaker than thin, closely conforming pads. The consequences of applying an insufficient amount of adhesive include, but are not limited to, immediate post-cure bond failure, delayed bond failure which may occur later in treatment, or white-spot lesions, i.e., demineralized tooth enamel surrounding the bracket, in some cases due to voids in the adhesive where plaque is unreachable by brushing. As such, direct bonding clinicians and indirect bonding technicians both tend to err on the side of excess adhesive to ensure void-free bonding pads.

Adhesive pre-coated brackets, such as APC II or APC PLUS brackets, available from 3M Company, St. Paul, Minn., USA, also follow this rule and come pre-coated with an excess of adhesive. This excess inevitably flashes out from the perimeter of the bonding base as the bracket is pressed into place and must be removed by the practitioner, a process that can be time consuming. The indirect bonding apparatuses of the present disclosure solve the problem, inter alia, of filling the gap between a patient's tooth having a unique anatomical shape and an orthodontic bracket having a standardized bonding base by providing an indirect bonding apparatus including a custom bracket bonding pad.

Before any embodiments of the present disclosure are explained in detail, it is to be understood that the phraseology and terminology used herein is for the purpose of description and should not be regarded as limiting. As used herein, the terms “including,” “comprising,” or “having” and variations thereof encompass the items listed thereafter and equivalents thereof, as well as additional items. All numerical ranges are inclusive of their endpoints and non-integral values between the endpoints unless otherwise stated.

As used herein the term “occlusal” means in a direction toward the outer tips of the patient's teeth.

As used herein the term “gingival” means in a direction toward the patient's gums or gingiva.

As used herein the term “labial” means in a direction toward the patient's lips.

As used herein the term “buccal” means in a direction toward the cheeks.

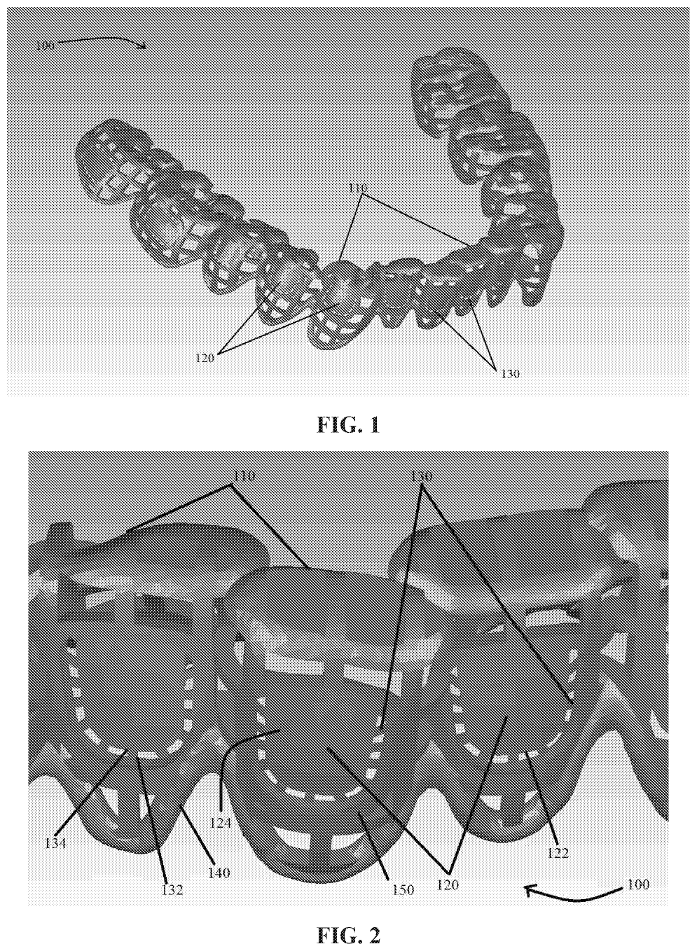

An apparatus for indirect bonding of orthodontic appliances according to one embodiment of the present disclosure is illustrated in FIGS. 1-3 and is broadly designated by the numeral 100. The apparatus 100 includes a plurality of receptacles 110 having an open framework (e.g., latticelike) construction. A receptacle 110 including an open framework construction may desirably allow the apparatus 100 to both flex during placement on the patient's dental arch and then shear during removal from the patient's dental arch after bonding of the orthodontic appliance is completed, allowing the apparatus 100 to be easily broken away as a means of removal. The open framework may be based on a variety of lattice structures, including, but not limited to, square or rectangular grid cells, hexagonal or honeycomb-shaped cells, triangular cells, randomly oriented intersecting lines, perforations, and combinations thereof.

Each receptacle 110 is configured to receive a specific tooth in a patient's dental arch. For example, a first receptacle 110 may be configured to receive a first tooth such as, for example, a central incisor, the first tooth having an outer surface and gingival margins, whereas a second receptacle 110 may be configured to receive a second tooth such as, for example, a lateral incisor, the second tooth having an outer surface and gingival margins. In some embodiments, a receptacle 110 may be created for each tooth in a patient's dental arch. In some embodiments, a receptacle 110 may be created for fewer than every tooth in a patient's dental arch. In the exemplary apparatus 100 shown in the drawings, the receptacles 110 are adapted to receive teeth of a patient's lower dental arch, although it should be understood in this regard that as an alternative the receptacles 110 may be constructed to receive teeth of the patient's upper dental arch. In some embodiments, the receptacle is configured to cover at least 20%, at least 30%, at least 40%, at least 50%, at least 60%, at least 70%, or at least 80% of the first tooth outer surface.

Referring to FIGS. 2 and 3, each receptacle 110 includes a custom bracket bonding pad 120, the bonding pad 120 having a perimeter 122, a first major surface 124 and a second major surface 126 opposite the first major surface 124. The first major surface 124 is configured to complement and provide a bonding surface for attachment of an orthodontic bracket 60. While it is possible for the first major surface 124 to be fabricated as a custom surface to accommodate a unique bracket bonding base, in preferred embodiments the first major surface 124 is fabricated to attach to an orthodontic bracket 60 having a standardized bonding base. The second major surface 126 is configured to complement a unique tooth surface and provide a bonding surface for attachment of the bonding pad 120 to that unique tooth surface.

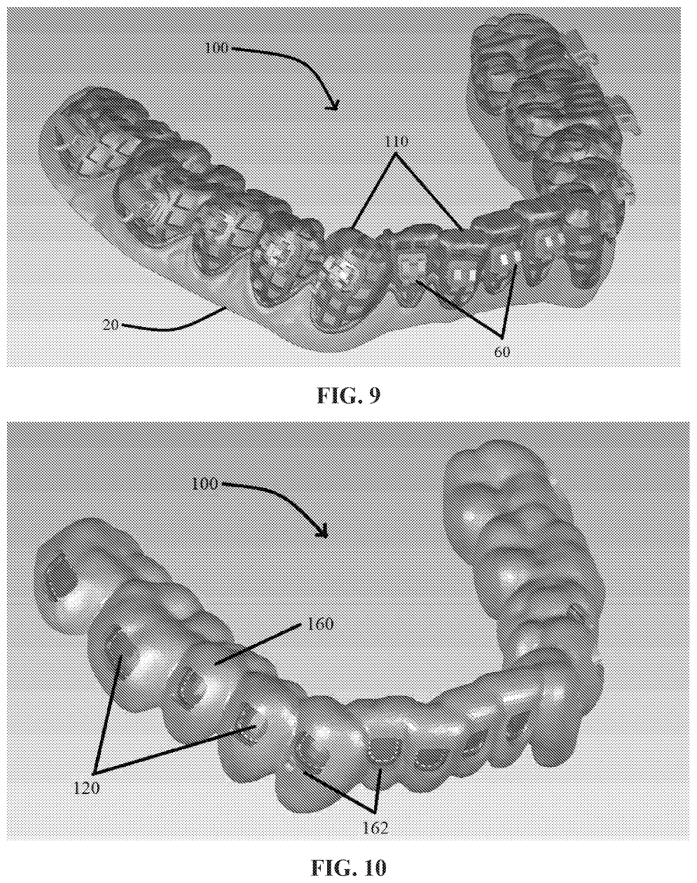

In some embodiments the receptacle 110 may include a boundary feature 140. The boundary feature 140 can provide additional stability to the apparatus 100, particularly when a plurality of receptacles 110 are joined together. As shown in FIGS. 1-3, the boundary feature 140 forms a continuous structure along the gingival edge of the receptacle 110 and may, in some embodiments and as shown in FIG. 9, follow the gingival margins of the patient's teeth when the apparatus 100 is placed on the patient's dental arch 20. In some embodiments the boundary feature 140 may be formed from the same material as other parts of the receptacle 110.

The receptacle 110 includes a frame 150 that encircles the bonding pad perimeter 122 and is attached to the perimeter 122 with a plurality of sprues 130. The sprues 130 are connected to the frame 150 at a first end 132 and to the perimeter 122 at a second end 134, thereby suspending the bonding pad 120 in its prescribed position adjacent the tooth outer surface when the apparatus 100 is engaged with the patient's dental arch. In some embodiments, and as shown in FIGS. 2 and 3, the sprues 130 can have a flat, rectangular shape and may be formed from the same material as the frame 150 and bonding pad 120. Desirably, the sprues 130 are configured so that they connect the bonding pad 120 to the receptacle 110 prior to attachment of the bonding pad 120 to a tooth surface but may be readily separated from the bonding pad 120 when required, i.e., after attachment of bonding pads 120 to teeth. As shown in FIG. 13, after the bonding pad 120 and bracket 60 are affixed to the tooth surface 40, all portions of the receptacle 110 except for the bonding pad 120 with its associated bracket 60 can be broken away and removed from the patient's dental arch 20.

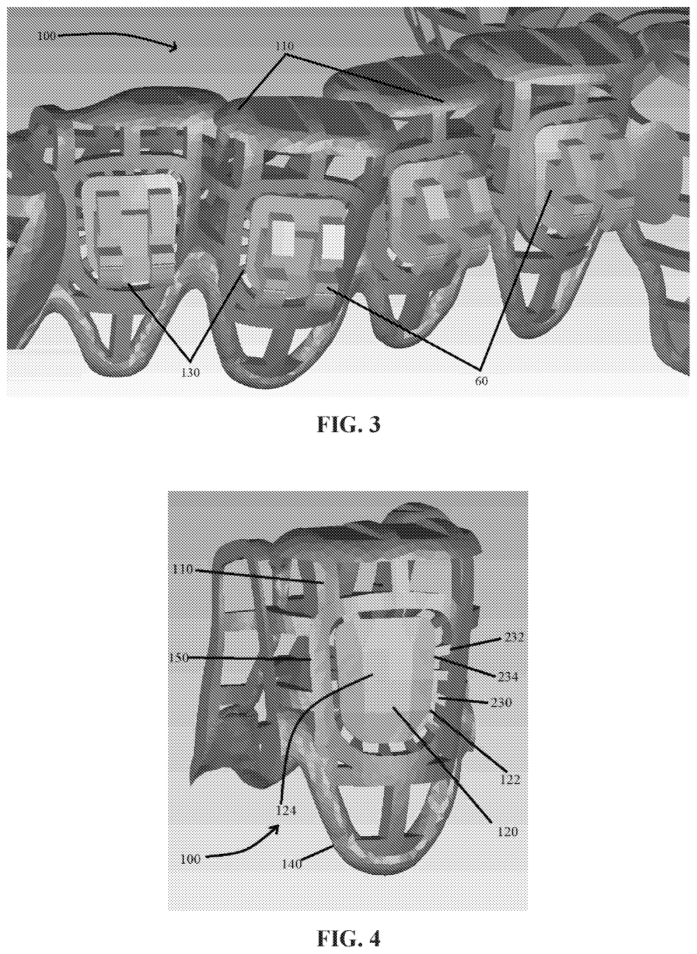

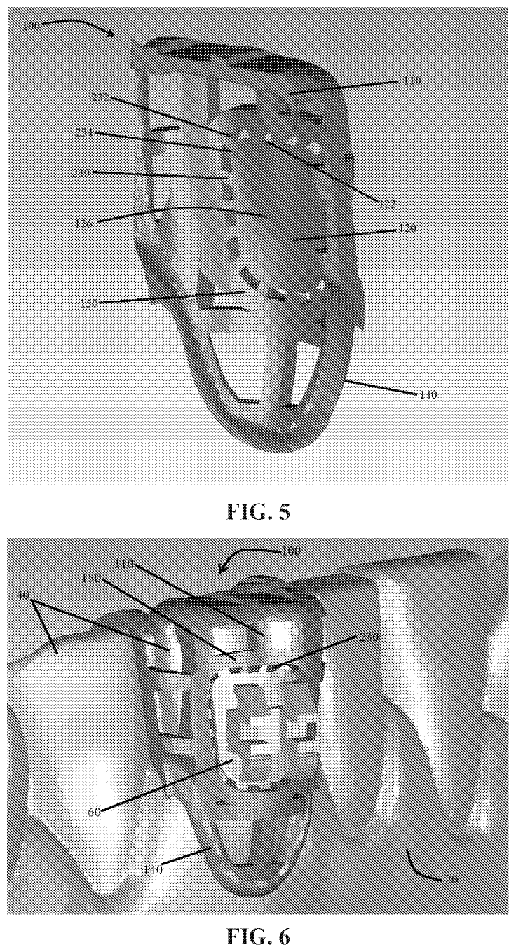

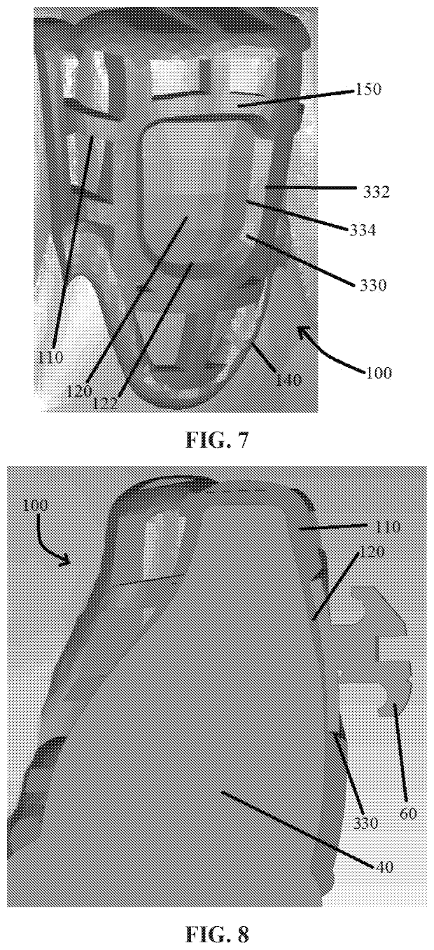

A second embodiment of a sprue 230 useful in the apparatus 100 of the present disclosure is shown in FIGS. 4-6. Sprue 230 includes a first end 232 and a second end 234, where the first end 232, connected to the frame 150, is thicker than the second end 234 which is connected to the bonding pad perimeter 122, i.e., the sprue 230 is wedge shaped. A third embodiment of a sprue 330 useful in the apparatus 100 of the present disclosure is shown in FIGS. 7 and 8. Sprue 330 includes a first end 332 and a second end 334, where the first end 332, connected to the frame 150, is thicker than the second end 334 which is connected to the bonding pad perimeter 122 and the sprue 330 forms a continuous surface around the bonding pad perimeter 122. The sprues 230 and 330 can provide at least two technical advantages when included in the apparatus 100. First, the sprue 230, 330 may provide a “ramp” for the bracket 60 to guide the bracket 60 to its optimal position on apparatus 100 when the bracket 60 is bonded to the first major surface 124 of the bonding pad 120. Second, the sprue 230, 330 may facilitate disconnection of the sprue 230, 330 from the bonding pad perimeter 122 preferentially to disconnection from the frame 150, resulting in a cleaner removal of apparatus 100 components from the patient's dental arch after attachment of the bonding pad 120 to the tooth surface.

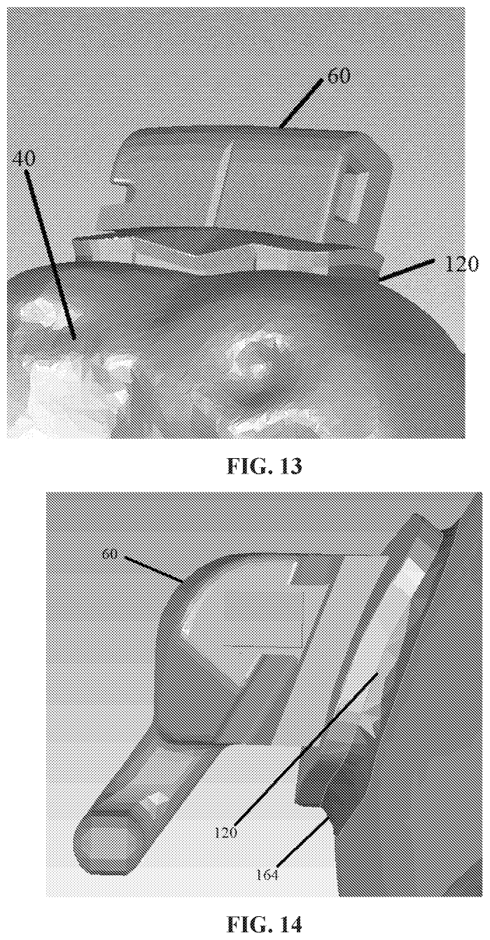

In some embodiments, bonding pad perimeter 122 may include a fillet 164 as shown in FIG. 14. The fillet 164 can be applied to any of the apparatus 100 embodiments described above to increase the bonded surface area at the tooth and to reduce the possibility of plaque build-up around the perimeter of the base. Plaque build-up can be a serious problem in orthodontic treatment, especially among patients with poor oral hygiene. The consequence may be “white spot lesions” surrounding the bracket bases, areas where the tooth enamel has demineralized due to prolonged exposure to acid byproducts from living bacteria. These bacteria, which also form plaque deposits on teeth, shelter in the corners between bracket bases and teeth where tooth brush bristles may have difficulty reaching them. The plaque build-up, and thus the risk of white spot lesions, can be worse where the gap thickness between the bracket base and tooth surface is large, and large gaps, such as, for example, gaps as large as 0.5 mm between buccal tube bases and molars, are known to be not uncommon.

An apparatus 100 of the present disclosure can be prepared by techniques known to those of ordinary skill in the relevant arts and as described in U.S. Pat. No. 9,763,750 (Kim et al.) which is hereby incorporated herein in its entirety. For example, in some embodiments, the apparatus 100 can be first digitally designed based on a malocclusion model of the teeth and a prescribed set of orthodontic brackets placed on the teeth according to a treatment plan. The apparatus 100 tray may be designed using automated methods that do not require technician or operator intervention using design inputs including, for example, a digital model of the teeth, a digital model of each bracket base (at least the surface that interfaces the tooth), transformation matrices that define the position of each bracket on its respective tooth, and inputs that define the dimensions of the various tray components. The output of the design process may be polygonal mesh file, such as, for example, an STL or PLY file. The apparatus 100 may then be fabricated using methods that can accurately reproduce the digital design, such as 3D printing or CNC machining. In some embodiments, the apparatus 100 may be formed using biocompatible, 3D-printable resins such as, for example, FULLCURE Tango Plus or FULLCURE 720 printing resin with an EDEN 500V brand 3-Dimensional Printing System (Objet Geometries, Ltd., Rehovot, ISRAEL).

Fabrication can be done at a centralized manufacturing facility, a dental laboratory, or the clinic location where the patient receives care. A set of brackets, preferably brackets with standard bonding bases, may then be bonded to the custom bracket bonding pad using a low viscosity adhesive, such as, for example, TRANSBOND Supreme LV Low Viscosity Light Cure Adhesive, available from 3M Company, St. Paul, Minn., USA. The patient's teeth may then be prepared for bonding using a product such as TRANSBOND Plus Self Etching Primer, TRANSBOND XT Primer, or TRANSBOND MIP Moisture Insensitive Primer, all available from 3M Company, St. Paul, Minn., USA. An adhesive may then be applied to the bonding sites on the patient's teeth, the bonding surfaces of the custom bracket bonding pads, or both, depending on the type of adhesive used. Suitable adhesive examples include: TRANSBOND Supreme LV, TRANSBOND IDB Pre-Mix Chemical Cure Adhesive, and SONDHI Rapid-Set Indirect Bonding Adhesive, all available from 3M Company, St. Paul, Minn., USA. Note that use of a filled adhesive is not critical due to the close conformity of the bonding surfaces with the custom pad in apparatuses 100 of the present disclosure; unfilled or lightly filled (e.g., less than 10 wt. % filler) may be used. The apparatus 100 is then placed on the patient's teeth, and the adhesive is allowed to cure. If a light-cure adhesive is used, then the bonding sites are illuminated using an appropriate curing light. In some instances, for light-cure adhesives to be supported, it is preferable to fabricate the apparatus 100 using a clear material or one that transmits the wavelength of light needed to cure that adhesive. The apparatus 100 is then removed from the patient's dental arch in such a way that the sprues between the tray and the custom pads are broken, leaving only the brackets and custom pads on the teeth. Optionally, the apparatus 100 may be broken away in parts to ease removal; lines of weakness or perforations may be present in the apparatus to aid in a multi-piece removal effort.

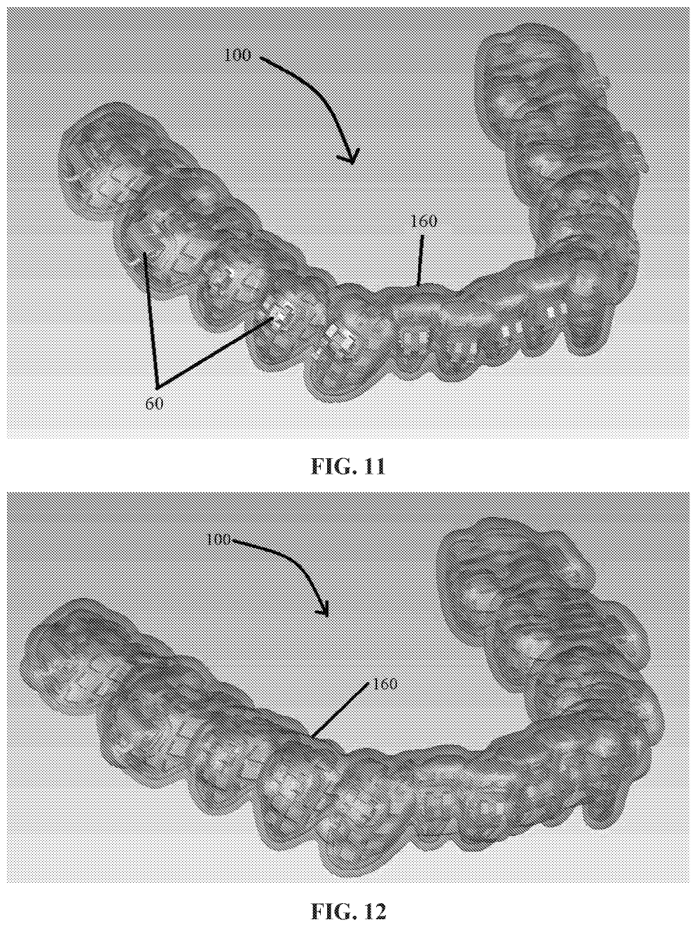

In some embodiments and as shown in FIGS. 10-12, 16, and 18, apparatus 100 may include overmolding 160. Overmolding 160 may comprise a flexible material to support and contain the frangible lattice structure of apparatus 100. In some embodiments, especially those incorporating a continuous ring surrounding each custom bracket bonding pad (see FIG. 7), the lattice structure is designed to be frangible, and it is preferably made of a brittle material that fractures when subjected to high mechanical stresses induced by manual bending, shearing, or twisting. However, for some such materials, the deliberate overstressing of the apparatus 100 could result in small pieces of broken apparatus 100 material to escape uncontrolled into the patient's mouth. To prevent such escape, a flexible overmolding 160 may be used to maintain control of these pieces as the rigid apparatus 100 material is broken after attachment of bracket bonding pads to the patient's dental arch. The overmolding 160 preferably includes material having a lower modulus of elasticity and a greater elongation before break than the apparatus 100 material. The overmolding 160 material is preferably flexible such as, for example, silicone RTV, an elastomeric polyurethane, or an elastomeric methacrylate polymer, which allows the more rigid apparatus 100 material to be intentionally deformed to its breaking point during apparatus 100 removal from the patient's dental arch. In some embodiments, the overmolding 160 material may be opaque. In some embodiments, the overmolding 160 material may be transparent.

Preparation of the overmolding 160 can be accomplished, for example, by injecting a flowable thermoset resin or molten thermoplastic into a two-part mold formed by the dental arch model and a hard outer shell offset by some amount from the arch model. Preferably, a material is used to form the overmolding 160 that will adhere to the material used to form the lattice structure of apparatus 100 to prevent broken pieces of the lattice structure from escaping into the patient's mouth. If adhesion is not inherent in the interface properties of the chosen materials, the lattice material may be first coated with an interface material that adheres to both the lattice material and the flexible material, thereby holding the two structural materials together. Alternatively, the lattice may incorporate undercuts or other geometric design features that result in a mechanical interlock between the lattice structure and the flexible material of the overmolding 160 after curing into a non-flowable rubber. Preparation of the overmolding 160 can be accomplished, for example, by 3D printing the apparatus 100 directly in two or more conjoined materials using a printer, such as the Connex3 by Stratasys Ltd., which uses PolyJet technology to achieve this.

In the embodiments shown in FIGS. 10, 11, and 16, custom bracket bonding pads 120 are exposed through apertures 162 in the flexible overmolding 160 material, thereby allowing brackets 60 to be inserted and bonded to the custom bracket bonding pads 120 after the apparatus 100 and overmolding 160 are formed. The same apertures 162 allow the lattice structure of the apparatus 100 to be removed from the dental arch while leaving the brackets 60 and the custom bracket bonding pads 120 bonded to the teeth.

In the embodiments shown in FIGS. 12 and 18 both apparatus 100 and the associated brackets are encapsulated in the overmolding 160 material. The overmolding 160 material serves to hold the brackets securely in their prescribed positions during bonding without prematurely breaking the frangible sprues that otherwise hold them in place, while also serving to seal out moisture from the bonding site of each bracket until the clinically-applied adhesive is cured. In this embodiment, it may be desirable to use a different flexible material than that used in the embodiment above because the brackets in this embodiment are intended to tear out of the flexible material upon apparatus 100 removal, after the brackets are securely bonded to the teeth. To achieve this, the force required to tear-out each bracket from the tray must be less than the force required to de-bond the bracket from the custom bracket bonding pad 120 and the custom bracket bonding pad 120 from the tooth. One example of a flexible material that may be suitable for use in this embodiment is MEMOSIL 2, a transparent A-silicone from Heraeus Kulzer.

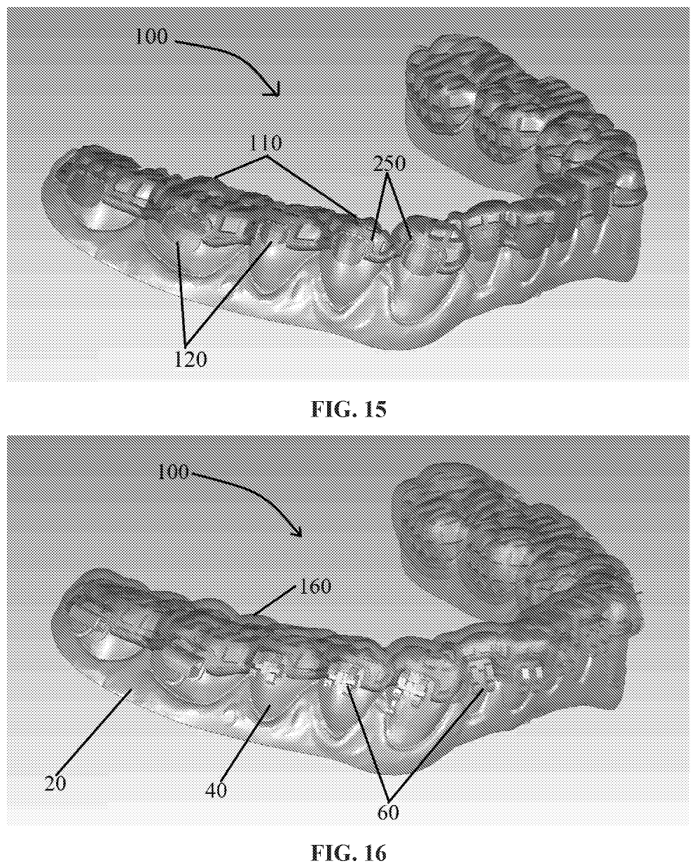

Another embodiment of apparatus 100 is shown in FIG. 15. Referring to FIG. 15, the gingival side of the custom bracket bonding pad 120 is not encircled by the frame 250, which may allow for easier tray removal after bracket bonding as the brackets do not have to pass through apertures in the apparatus 100. Instead, the apparatus 100 can be removed in a predominantly occluso-gingival direction without causing interference between the brackets and the apparatus 100, except to the degree that the frangible sprues require breakage to allow for apparatus 100 removal. In some embodiments, the frame 250 surrounds 25% to 95%, 25% to 85%, or 25% to 75% (e.g., 50%) the bracket pad 120 perimeter. In some embodiments, the frame 250 surrounds at least 25%, at least 50%, at least 75%, at least 85%, or at least 95% of the bracket pad 120 perimeter. In some embodiments, the frame 250 surrounds less than 95%, less than 85%, or less than 75% of the bracket pad 120 perimeter. As shown in FIG. 16, an apparatus 100 having a frame 250 that encircles less than 100% of the custom bracket bonding pad 120 may also be combined in some embodiments with an overmolding 160.

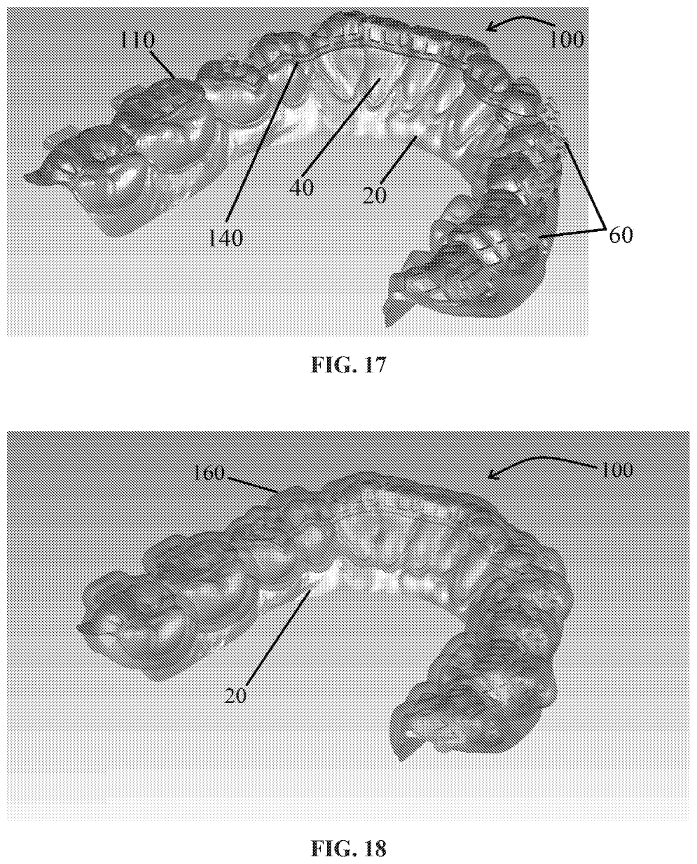

Another embodiment of apparatus 100 is shown in FIG. 17. Referring to FIG. 17, in this embodiment, at least a portion of the lingual tooth surfaces 40 is exposed after the apparatus 100 is seated on the dental arch 20. This may facilitate apparatus 100 removal after bonding by allowing the apparatus 100 to be withdrawn in a predominantly labial or buccal direction, normal to the surfaces of the teeth. As shown in FIG. 18, an apparatus 100 as shown in FIG. 17 may also be combined in some embodiments with an overmolding 160.

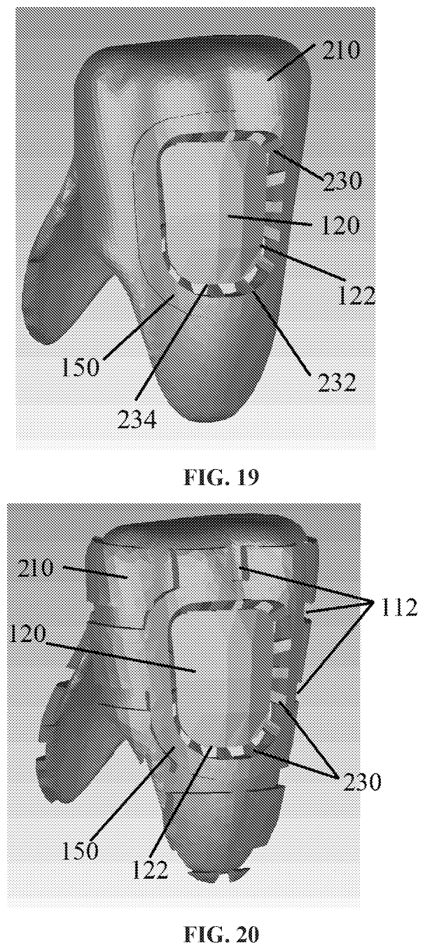

Another embodiment of apparatus 100 is shown in FIGS. 19 and 20. Referring to FIG. 19, this embodiment of apparatus 100 employs receptacles 210 having a continuous surface, rather than receptacles 110 having an open framework (e.g., latticelike) construction, as in apparatus 100 embodiments described above. In this embodiment, to ease donning and doffing of the apparatus 100, the apparatus 100 material may have a lower rigidity or modulus of elasticity than the material used in open framework embodiments, thus allowing the apparatus 100 to flex without breaking as it passes over the changing tooth surfaces. In some embodiments, and as shown in FIG. 20, receptacles 210 may include one or more score lines 212 to concentrate stress along predetermined lines and thus control breakage when the apparatus 100 is removed from the patient's dental arch.

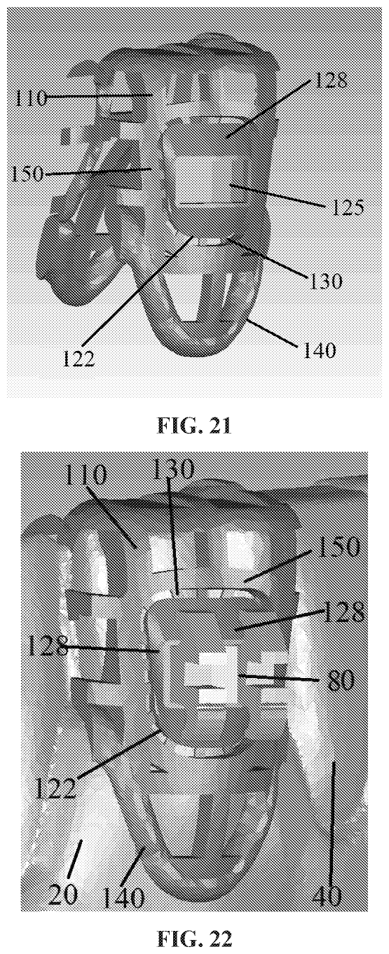

Another embodiment of apparatus 100 is shown in FIGS. 21 and 22. Referring to FIGS. 21 and 22, in this embodiment of apparatus 100, the bracket base/bonding pad 128 is not merely a gap-filling interface between a standard bracket base and a tooth 40, rather, it is an entire custom base for a labial bracket body 80. The bracket base/bonding pad 128 incorporates both standardized and customized features. The side of the bracket base/bonding pad 128 that interfaces with the tooth 40 is customized to conform exactly to the tooth 40 surface when placed at the prescribed position and orientation according to the digital treatment plan. The outer surface of the bracket base/bonding pad 128 incorporates a standardized interface, in this embodiment, a bracket body bed 125 that is configured to mate with a standardized, mass-produced bracket body 80. The bracket body 80 may be fabricated using conventional, low-cost manufacturing methods, such as, for example, machining, metal injection molding (“MIM”), or ceramic molding and sintering. Bracket body 80 materials may include, but are not limited to, metals, such as stainless steel, titanium, nickel-titanium, cobalt-chromium, nickel-chromium, gold, and combinations thereof and ceramics, such as alumina or zirconia. In this embodiment, the bracket body 80 does not require a base that is designed to mate with a statistically normal tooth surface. This can reduce the amount of bulk in the bracket base by eliminating material that would otherwise fill a gap between the base and the tooth. The result may be a lower profile, more comfortable bracket.

The mating surfaces of the bracket base/bonding pad 128 and bracket body 80 need not be designed as shown in FIGS. 21 and 22. The bracket body bed 125 can be included on the bracket body 80, and a complementary protrusion can be included on the bracket base/bonding pad 128. In some embodiments, planar mating surfaces may be used on both components. In some embodiments, to reduce stress at the joint, the bracket body 80 may incorporate a flange (not shown) to increase the surface area at the joint. In some embodiments, instead of bonding the two components at the joint, a snap-fit mechanism (not shown) may be employed.

Bracket bodies may be selected from a library having different combinations of torque, angulation, in/out, hooks, tie-wings, tubes, etc. However, given that the base is a customized component, the amount of variation in the library of bracket bodies may be reduced by incorporating at least some of the bracket prescription into the base. As such, a continuous range of torques, angulations, and in/outs may be achieved, allowing for prescription values anywhere in between the discrete values embodied in the bracket bodies themselves. Similarly, the number of bracket variations needed may also be reduced by the fact that the same bracket body can be applied to several different teeth in the dental arch. This may be accomplished by removing the base as a variable that adds to the number of permutations needed in the bracket design.

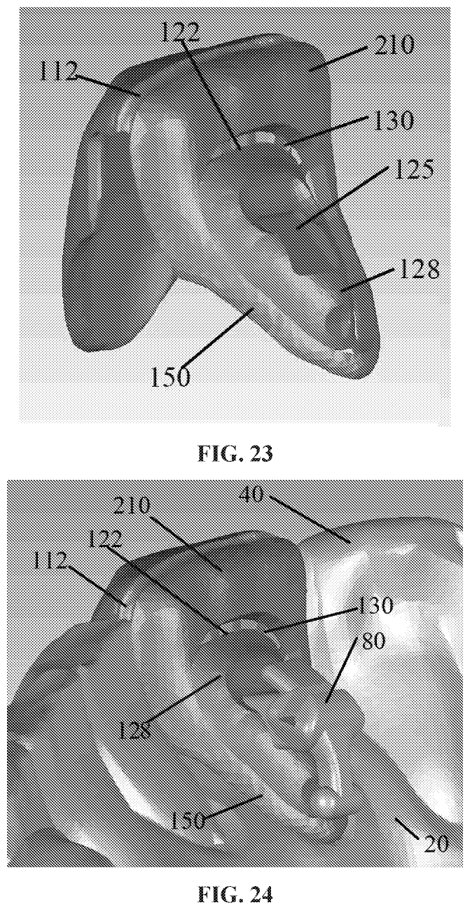

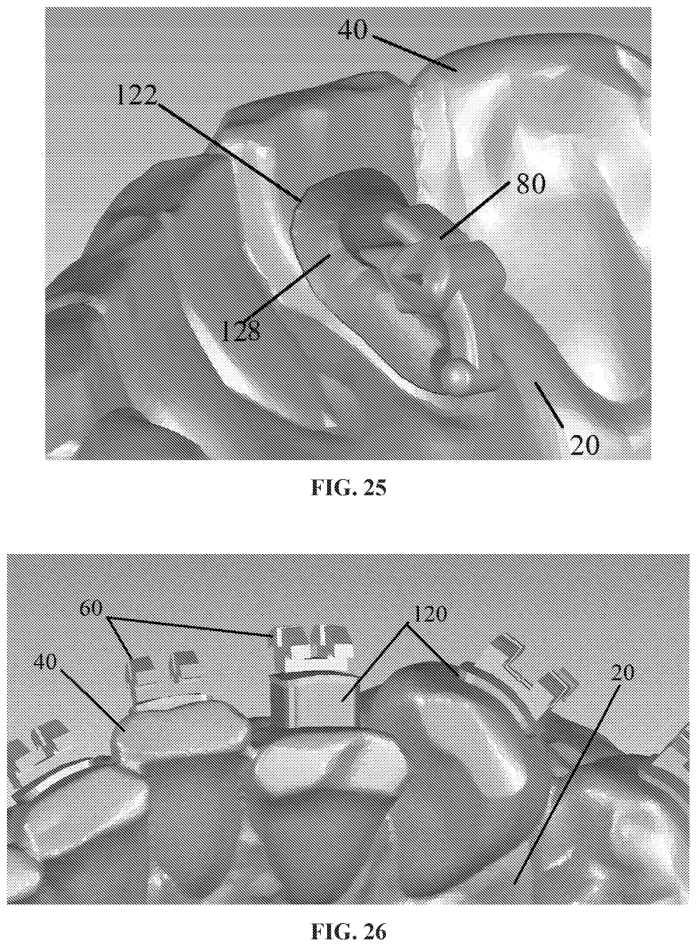

Another embodiment of apparatus 100 is shown in FIGS. 23 and 24. Referring to FIGS. 23 and 24, this embodiment of apparatus 100 is similar to the embodiment of FIGS. 21 and 22, except that it includes a bracket base/bonding pad 128 for a lingual bracket 80 and the apparatus 100 incorporates a receptacle 210 having a continuous surface and a score line 212 along the incisal edge. By placing the score line 212 along the incisal edge (or marginal ridge on cuspids, bicuspids, and molars), the receptacle 210 may be controllably broken into separate labial and lingual halves, making it easier to withdraw the lingual portion of the apparatus 100 from the tooth 40. FIG. 25 shows the dental arch 20 of FIG. 24 after portions of the apparatus 100 have been removed. It is contemplated that the disclosed features can be applied in a variety of combinations, such as, for example, using an open framework receptacle with a lingual bracket, or using a plurality of continuous-surface receptacles incorporating incisal score lines with labial brackets.

The condition shown in FIG. 26 demonstrates how the custom bracket bonding pad 120 can be designed to add significantly to the in/out dimension of a bracket 60. In this case, the custom bracket bonding pad 120 serves to position the slot of the bracket 60 closer to the nominal path of the archwire, thereby allowing the archwire to engage the bracket without the use of a tie-back. Typically the orthodontist would have to loop a thin stainless steel ligature wire around the archwire and tie back to the bracket 60 by looping around the tie-wings and twisting the ends of the wire closed, and in some cases, the orthodontist would elect not to engage the bracket 60 at all, hoping that enough space is created by use of braces on the surrounding teeth, which is not an efficient practice. With the apparatus 100 described above, a bracket 60 having a shorter custom bracket bonding pad 120 would be bonded later in treatment, once the bracket slot is within reach of the archwire.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An apparatus for indirect bonding of orthodontic appliances, the apparatus comprising:
a first receptacle, the first receptacle configured to receive a first tooth, the first tooth having an outer surface and gingival margins; and
a first bracket bonding pad, the first bracket bonding pad including a first bonding surface and a first perimeter, the first bonding surface configured to complement contours of a portion of the first outer surface of the first tooth,
wherein the first receptacle comprises a first frame, the first frame at least partially surrounding the first bracket pad first perimeter, wherein the first receptacle is joined to the first bracket bonding pad with a sprue, the sprue including a first end and a second end, wherein the first end of the sprue is attached to the first frame and the second end of the sprue is attached to the first bracket bonding pad first perimeter, and wherein the first bracket bonding pad is formed integrally with the first receptacle.

2. The apparatus of claim 1, wherein the first receptacle is configured to cover at least 20% of the first tooth outer surface.

3. The apparatus of claim 1, wherein the first receptacle further comprises a boundary feature.

4. The apparatus of claim 3, wherein the boundary feature is configured to follow the gingival margins of the first tooth.

5. The apparatus of claim 1, wherein the first receptacle includes an open framework.

6. The apparatus of claim 5, wherein the open framework comprises a lattice structure including a cell, the cell having a shape selected from the group consisting of a regular polygon, an irregular polygon, an ellipse, and combinations thereof.

7. The apparatus of claim 1, wherein the first frame surrounds at least 25% of the first bracket pad first perimeter.

8. The apparatus of claim 1, wherein the apparatus further comprises a second receptacle, the second receptacle configured to receive a second tooth, the second tooth having an outer surface and gingival margins; and a second bracket bonding pad, the second bracket bonding pad including a second bonding surface and a second perimeter, the second bonding surface configured to complement contours of a portion of the outer surface of the second tooth, wherein the second receptacle comprises a second frame, the second frame at least partially surrounding the second bracket pad second perimeter, wherein the second receptacle is joined to the second bracket bonding pad with a second sprue, the second sprue including a first end and a second end, wherein the first end of the second sprue is attached to the second frame and the second end of the second sprue is attached to the second bracket bonding pad second perimeter, wherein the second bracket bonding pad is formed integrally with the second receptacle, and wherein the first receptacle is joined to the second receptacle.

9. The apparatus of claim 8, wherein the second receptacle is configured to cover at least 20% of the second tooth outer surface.

10. The apparatus of claim 9, wherein the second receptacle further comprises a boundary feature.

11. The apparatus of claim 10, wherein the boundary feature is configured to follow the gingival margins of the second tooth and wherein the boundary feature of the second receptacle is joined to the boundary feature of the first receptacle.

12. The apparatus of claim 8, wherein the second receptacle includes an open framework.

13. The apparatus of claim 8, wherein the second frame surrounds at least 25% of the second bracket pad second perimeter.

14. The apparatus of, wherein the apparatus comprises a biocompatible, 3D-printable resin.

15. The apparatus of, wherein the apparatus is made using 3D printing, computer numerical control machining, and combinations thereof.

16. The apparatus of claim 1, wherein the first receptacle is configured to cover at least 60% of the first tooth outer surface.

17. The apparatus of claim 1, wherein the first frame surrounds at least 75% of the first bracket pad first perimeter.

18. The apparatus of claim 8, wherein the second receptacle is configured to cover at least 60% of the second tooth outer surface.

19. The apparatus of claim 8, wherein the second frame surrounds at least 75% of the first bracket pad first perimeter.
